(19) United States
(12) Patent Application Publication
(10) Pub. No.: US 2017/0008023 A1
(43) Pub. Date: Jan. 12, 2017

(54) NOZZLE, APPLICATION DEVICE, AND METHOD OF APPLYING FLUID

(71) Applicant: Heishin Ltd., Kobe-shi, Hyogo (JP)

(72) Inventors: Nobuhisa SUHARA, Nagahama-shi (JP); Hideaki WAKIZAWA, Nagahama-shi (JP)

(73) Assignee: HEISHIN LTD., Kobe-shi, Hyogo (JP)

(21) Appl. No.: 15/115,398

(22) PCT Filed: Jan. 26, 2015
(86) PCT No.: PCT/JP2015/052079

§ 371 Date: Jul. 29, 2016

(30) Foreign Application Priority Data
Jan. 29, 2014 (JP) 2014-014641

(51) Int. Cl. B05C 5/02; B05C 11/06

(52) U.S. Cl. CPC B05C 5/0254; B05C 11/06

(57) ABSTRACT

The purpose of the present invention is to provide a nozzle and an application apparatus which can obtain sufficient application quality even when fluid with high viscosity is applied, and a method of applying the fluid thereof. The nozzle includes a discharging means having a wide discharge port that is opened so that the fluid is dischargeable in a belt shape to be applied to an application object, and a cutting means for cutting the fluid discharged from the discharge port. In the nozzle, the cutting means is cuttable of the fluid by a wire that is movable from one side to the other side of an opening area that constitutes the discharge port.

This application is the U.S. National Phase of International Patent Application No. PCT/JP2015/052079, filed on Jan. 26, 2015, entitled “NOZZLE, APPLICATION DEVICE, AND METHOD FOR APPLYING FLUID,” and claims priority under 35 U.S.C. §119 to Japanese Patent Application No. 2014-014641, filed on Jan. 29, 2014, which are hereby expressly incorporated by reference in their entirety for all purposes.

### TECHNICAL FIELD

The present invention relates to a nozzle which can suitably be used for applications, such as applying fluid with high viscosity to an object to be applied, an application apparatus provided with the nozzle, and a method of applying the fluid.

### BACKGROUND ART

Conventionally, application apparatuses which are disclosed in the following Patent Documents 1: JP2004-148167A and 2: WO2007/032060A1 have been used in order to apply fluid to an object to which the fluid is applied (i.e., application object). The application apparatus disclosed in Patent Document 1 is to accumulate the fluid on a nozzle, when it uses the nozzle to apply the fluid to an object to be coated which has an uneven surface. This application apparatus applies the fluid by contacting the nozzle to the application object which is moving in a given conveying direction, while it pushes the applied fluid against the application object by injecting heated pressurized gas.

Further, the application apparatus disclosed in Patent Document 2 is for uniformly applying an amount and shape of the fluid (high viscosity material) to the application object, such as an automobile sheet steel. Similar to the application apparatus according to Patent Document 1, this application apparatus is to fix the fluid applied from the nozzle (application gun) to the application object by gas injected from a gas injection instrument.

Here, if the fluid applied to the application object is, for example, high-viscosity liquid, such as a sheet-steel reinforcement material to reinforce the automobile body sheet steel, an anti-drip (cut-off) performance of the fluid is very bad. Thus, in the conventional technologies, when the fluid is applied to the application object, sufficient application quality may not be obtained because, for example, terminated ends of the fluid may not be aligned or may be irregular. In addition, if the terminated ends are in a dripping state where the terminated ends are not aligned or are irregular, the fluid is very likely to adhere near a discharge port of the nozzle used for applying the fluid. Thus, for example, if the terminated ends are not aligned or are irregular in the application work done previously, starting ends of the next fluid applied are also not aligned or are also irregular. Therefore, sufficient application quality may not be obtained.

Further, in the conventional technologies, since the anti-drip performance of the fluid is bad, it is necessary to reduce the clearance (gap) between the tip end of the nozzle and the application object. However, if the clearance between the nozzle and the application object is reduced in order to improve the anti-drip performance, there is a problem that the nozzle may interfere with the application object.

Thus, one purpose of the present invention is to provide a nozzle and an application apparatus which can obtain sufficient application quality, without extremely reducing the clearance with the application object, even when the fluid with high viscosity is applied, and also to provide a method of applying the fluid.

### SUMMARY OF THE INVENTION

In order to solve the problems described above, according to one aspect of the present invention, a nozzle is provided, which includes a discharging means having a wide discharge port that is opened so that fluid is dischargeable in a belt shape to be applied to an application object, and a cutting means for cutting the fluid discharged from the discharge port. The cutting means is cuttable of the fluid by a wire that is movable from one side to the other side of an opening area that constitutes the discharge port.

The nozzle according to the one aspect of the present invention is provided with the cutting means which is cuttable of the fluid by the wire, and the fluid discharged from the discharge port can be cut by moving the wire from one side to the other side of the opening area that constitutes the discharge port. Thus, even if the fluid used for application is high-viscosity liquid with very poor anti-drip performance, the cutting means can cut the fluid neatly (gives a clean cut) when terminating the discharge of the fluid for the application. Therefore, in accordance with the nozzle according to the one aspect of the present invention, a reduction of application quality, resulted from irregularities on terminated ends of the fluid applied to the application object and/or starting ends of the next application work, can be avoided without making a clearance with the application object extremely small.

Here, if the high-viscosity liquid is used as the fluid for the application, the application quality may be degraded, resulted from that the applied fluid floats at an intermediate location or a terminated portion of an application course. Therefore, the nozzle according to the one aspect of the present invention desirably has a configuration that can certainly fix the fluid to the application object.

Based on the above knowledge, the nozzle according to the one aspect of the present invention preferably includes a fixing means for fixing the fluid to the application object by blowing compressed gas to the fluid discharged from the discharging means toward the application object.

The nozzle according to the one aspect of the present invention is capable of fixing to the application object the fluid discharged from the discharging means toward the application object by using the fixing means. Thus, even if high-viscosity liquid is used as the fluid for the application, it is reduced that the applied fluid floats at the intermediate location or the terminated portion of the application course, and it becomes possible to improve the application quality.

According to another aspect of the present invention, a nozzle is provided, which includes a discharging means having a wide discharge port that is opened so that fluid is dischargeable in a belt shape to be applied to an application object, a fixing means for fixing the fluid to the application object by blowing compressed gas to the fluid discharged from the discharging means toward the application object, and a cutting means for cutting the fluid discharged from the discharge port.

The nozzle according to another aspect of the present invention is provided with the cutting means which is cuttable of the fluid. Thus, even if the fluid used for the application is high-viscosity liquid with very poor anti-drip performance, the cutting means can cut the fluid neatly when terminating the discharge of the fluid for the application. Therefore, in accordance with the nozzle according to another aspect of the present invention, the reduction of the application quality, resulted from the irregularities on the terminated ends of the fluid applied to the application object and/or the starting ends of the next application work, can be avoided without making the clearance with the application object extremely small.

The nozzle according to another aspect of the present invention includes the fixing means, and can fix the discharged fluid to the application object. Thus, it is reduced that the applied fluid floats at the intermediate location or the terminated portion of the application course, and it becomes possible to improve the application quality.

In the nozzle according to another aspect of the present invention, the cutting means may be cuttable of the fluid by a wire that is movable from one side to the other side of an opening area that constitutes the discharge port.

With such a structure, the fluid discharged from the discharge port can be sharply cut. Thus, it can be reduced that the terminated ends of the fluid applied to the application object become irregular. Further, by moving the wire along the discharge port, it can be reduced that the fluid remains near the discharge port. Therefore, also the starting ends of the next application work can have a sharp shape.

Here, the present inventors have diligently examined measures for making the terminated ends of the fluid applied in the belt shape and the starting ends of the next application work sharper when the fluid is cut by the wire. As a result, it is found that the ends of the fluid become sharper by attaching the wire so as to cross and bridge over the opening area which constitutes the discharge port in short-side directions, and moving the wire from one side to the other side in a long-side direction to cut the fluid and, thus, the application quality is improved.

In the nozzle according to another aspect of the present invention, the wire may be oriented in short-side directions of the opening area that constitutes the discharge port, and may be cuttable of the fluid by moving from one side to the other side in a long-side direction.

With such a structure, the terminated ends of the fluid applied to the application object and the starting ends of the fluid to be applied in the next application work become sharper and the application quality can be improved.

In the nozzle according to another aspect of the present invention, the cutting means may cut the fluid by blowing the compressed gas to the fluid.

By adopting the above structure, even if the fluid used for the application is high-viscosity liquid with very poor anti-drip performance, the cutting means can cut the fluid neatly. Thus, the reduction of the application quality, resulted from the irregularities on the terminated ends of the fluid applied to the application object and/or the starting ends of the next application work, etc., can be avoided without making the clearance with the application object extremely small.

In the nozzle according to another aspect of the present invention, a passage through which the fluid passes from a supply source side to the discharge port may be provided, a flow path cross-sectional area of a part of the passage on the discharge port side being smaller than a flow path cross-sectional area on the supply source side.

With such a structure, even if the fluid used for the application is the high in viscosity as described above, sufficient discharge pressure can be obtained.

According to yet another aspect of the present invention, an application apparatus is provided, which includes the nozzle according to the previous aspect of the present invention, and a fluid feeding device for supplying the fluid to the nozzle. The application apparatus is executable of a discharging operation where the fluid is discharged from the discharging means of the nozzle toward the application object, and a cutting operation where, when ending the discharging operation, a wire that constitutes the cutting means is moved from one side to the other side of an opening area that constitutes the discharge port, and cuts the fluid.

In the application apparatus according to yet another aspect of the present invention, the wire that constitutes the cutting means is moved from one side to the other side of the opening area that constitutes the discharge port, and the fluid can be cut. Thus, by executing the cutting operation when ending the discharging operation, the terminated ends of the fluid applied to the application object and the starting ends of the next application work become neat and the application quality can be improved. Further, it is not necessary to make the clearance between the nozzle and the application object extremely small, and a problem of the nozzle and the application object being, for example, interfered, can also be reduced.

The application apparatus according to yet another aspect of the present invention may include a fixing means that is executable of a fixing operation where the fluid is fixed to the application object by blowing compressed gas to the fluid discharged from the discharging means toward the application object. The fluid may be applicable to the application object by executing the discharging operation and the fixing operation.

In the application apparatus according to yet another aspect of the present invention, by executing the fixing operation by the fixing means, the fluid discharged from the discharging means toward the application object can be fixed to the application object. Thus, in accordance with this application apparatus, even if high-viscosity liquid is used as the fluid for the application, it is reduced that the applied fluid floats at the intermediate location or the terminated portion of the application course, and it becomes possible to improve the application quality.

In the application apparatus according to yet another aspect of the present invention, the fixing operation may continue from the start to the end of the discharging operation.

With such a structure, it is possible to firmly fix the fluid to the application object not only at the terminated portion of the fluid applied to the application object but also at the intermediate location of the application course. Therefore, it is possible to further improve the application quality.

Here, the inventors of the present invention have diligently examined and found that when the fluid is applied by executing the discharging operation together with the fixing operation, there is a possibility that the cut portion does not become neat if the cutting operation is executed while the fixing operation is continued when ending the discharging operation to terminate the discharge. Thereby, the knowledge was obtained that, when executing the cutting operation, it is preferably executed in a state where the fixing operation is suspended.

On the other hand, if the fluid used for the application is high in viscosity, the anti-drip performance is very poor. Thus, only by executing the cutting operation in the state where the fixing operation is suspended, there is still a possibility that when cutting the fluid discharged from the discharge port at the terminated portion of the application course, the terminated portion floats toward the nozzle.

Based on the above knowledge, in the application apparatus according to yet another aspect of the present invention, when ending the discharging operation, the cutting operation may be executed in a state where the fixing operation is suspended, and after the execution of the cutting operation, the fixing operation may be resumed to fix to the application object, a terminated portion of the fluid discharged to the application object.

In the application apparatus according to the aspect of the present invention, since the fixing operation is suspended when ending the discharging operation, the fluid can be cut neatly. Further, the fixing operation is resumed after the execution of the cutting operation to fix to the application object the terminated portion of the fluid discharged to the application object. Thus, in accordance with the application apparatus according to yet another aspect of the present invention, the cut shape of the terminated portion of the fluid is neat on the application object, and the fluid is firmly fixed without floating, etc.

In the application apparatus described above, the fluid feeding device may pump the fluid by a uniaxial eccentric screw pump.

By using the uniaxial eccentric screw pump as the fluid feeding device, the fluid can stably be supplied to the nozzle at a constant pressure and with high precision without pulsation etc. Therefore, in accordance with the application apparatus according to yet another aspect of the present invention, the application quality of the fluid to the application object can further be improved.

According to a further aspect of the present invention, a method of applying fluid is provided, which includes applying the fluid to an application object by executing a discharging operation where the fluid is discharged toward the application object from a discharging means of a nozzle including the discharging means having a wide discharge port that is opened so that the fluid is dischargeable in a belt shape to be applied to the application object and a cutting means for cutting the fluid discharged from the discharge port. The method further includes cutting the fluid, when the applying is ended, by moving a wire that constitutes the cutting means from one side to the other side of an opening area that constitutes the discharge port.

In the method of applying the fluid according to the further aspect of the present invention, the fluid can be cut in the cutting the fluid after the fluid is applied to the application object in the applying the fluid. Since the cutting means used in the applying method according to the further aspect of the present invention is to cut the fluid by moving the wire from one side to the other side of the opening area that constitutes the discharge port, even if high-viscosity liquid is used as the fluid for the application, the fluid can be cut neatly. Thus, in accordance with the method of applying the fluid according to the further aspect of the present invention, the terminated ends of the fluid applied to the application object and the starting ends of the next application work become neat and the application quality can be improved. Further, in accordance with the teachings of this applying method, it is not necessary to make the clearance between the nozzle and the application object extremely small, and the problem of the nozzle and the application object being, for example, interfered, can also be reduced.

In the method of applying the fluid according to the further aspect of the present invention, the nozzle may further include a fixing means for fixing the fluid to the application object by blowing compressed gas to the fluid discharged from the discharging means toward the application object. During the applying the fluid, a fixing operation where the compressed gas is blown by the fixing means to fix the fluid may be executed, in addition to the discharging operation.

As the method of applying the fluid according to the further aspect of the present invention, by executing the fixing operation in addition to the discharging operation, the fluid applied to the application object can be prevented from floating and the application quality can further be improved.

In the method of applying the fluid according to the further aspect of the present invention, the cutting of the fluid may be executed after the step of applying the fluid is ended by suspending the discharging operation and the fixing operation. The method may further include a step of, after execution of the cutting the fluid step, fixing to the application object a terminated portion of the fluid discharged to the application object by resuming the fixing operation.

In the method of applying the fluid according to the further aspect of the present invention, the step of cutting the fluid is executed after the step of applying the fluid is ended by suspending the discharging operation and the fixing operation. That is, in the cutting the fluid step, the fluid can be cut neatly without being exposed to an air current, since the fixing operation is not executed and the air current is stopped. Further, in the step of fixing the terminated portion after the execution of the cutting the fluid step, the fixing operation is resumed, and the terminated portion of the discharged fluid can be fixed to the application object. Thus, in accordance with the method of applying the fluid according to the further aspect of the present invention, the cut shape of the terminated portion of the fluid can be neat on the application object, and the fluid can be firmly fixed without floating from a surface of the application object.

Accordingly, embodiments of the present invention provide a nozzle and an application apparatus which can obtain sufficient application quality even when fluid with high viscosity is applied, and a method of applying the fluid thereof

### BRIEF DESCRIPTION OF DRAWINGS

FIG. 1 is a front elevational view illustrating an application apparatus according to one embodiment of the present invention.

FIGS. 2A-2B are perspective views illustrating a nozzle used for the application apparatus illustrated in FIG. 1.

FIG. 3A is a right side view of the nozzle illustrated in FIG. 2, FIG. 3B is a cross-sectional view thereof, FIG. 3C is a left side view thereof, and FIG. 3D is a low side view thereof.

FIG. 4A is an enlarged view of a substantial part in the cross-sectional view illustrated in FIG. 3B, and FIG. 4B is an enlarged view of a substantial part of FIG. 2B.

FIGS. 5A-5B are perspective views illustrating a first structure which constitutes the nozzle illustrated in FIGS. 2A-2B.

FIG. 6A is a plan view illustrating the first structure illustrated in FIGS. 5A-5B, FIG. 6B is a cross-sectional view taken along a line A-A of FIG. 6C, FIG. 6C is a left side view thereof, and FIG. 6D is a right side view thereof.

FIGS. 7A-B are perspective views illustrating a second structure which constitutes the nozzle illustrated in FIGS. 2A-2B.

FIG. 8A is a left side view illustrating the second structure illustrated in FIGS. 7A-7B, FIG. 8B is a front elevational view thereof, and FIG. 8C is a right side view thereof.

FIGS. 9A-B are perspective views illustrating a third structure which constitutes the nozzle illustrated in FIGS. 2A-2B.

FIG. 10A is a left side view of the third structure illustrated in FIG. 9A, FIG. 10B is a bottom view thereof, and FIG. 10C is a cross-sectional view taken along a line A-A of FIG. 10A.

FIG. 11 is a flowchart illustrating one example of an operation according to the application apparatus illustrated in FIG. 1.

FIG. 12 is a timing chart illustrating one example of the operation according to the application apparatus illustrated in FIG. 1.

FIG. 13A is an enlarged cross-sectional view of a substantial part of a nozzle according to a modification, and FIG. 13B is a flow path structure diagram illustrating one example of a supply system of compressed gas connected to the nozzle illustrated in FIG. 13A.

FIG. 14A is a schematic diagram illustrating a state where fluid is applied to an application object by the application apparatus illustrated in FIG. 1, and FIG. 14B is an enlarged view of a substantial part illustrating a state where the fluid is applied using the application apparatus illustrated in FIG. 1.

### DETAILED DESCRIPTION OF THE INVENTION

Hereinafter, a structure of an application apparatus 10 according to one embodiment of the present invention is described in detail, while focusing on a structure of a nozzle 30. In addition, a method of applying fluid P which is implemented using the application apparatus 10 is described. Note that, in the following description, vertical and horizontal spatial relationships are described based on the illustrated states, unless otherwise specified.

### [Structure of Application Apparatus 10]

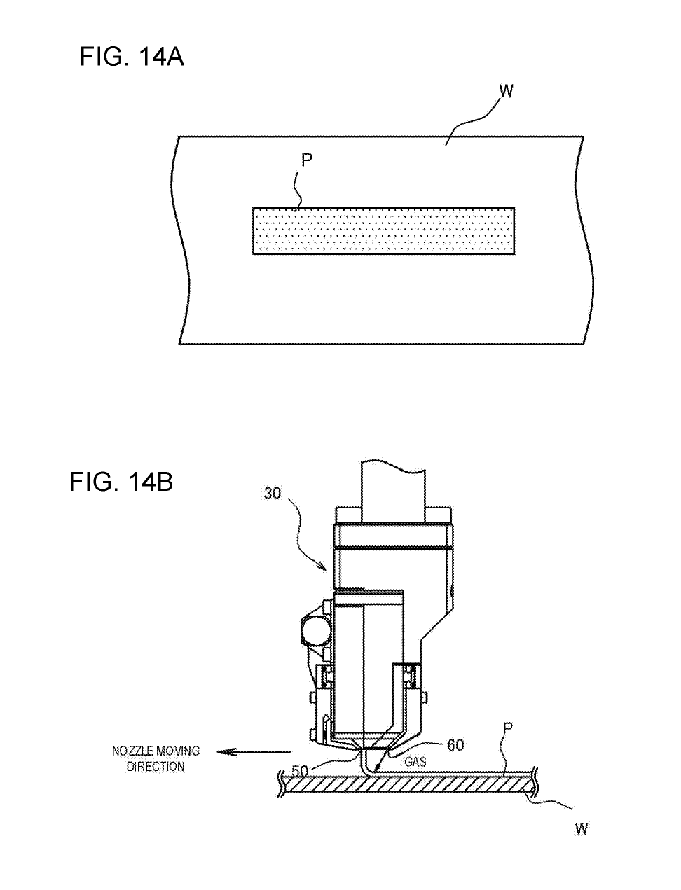

As illustrated in FIG. 14A, the application apparatus 10 is an apparatus which can be used for applying high-viscosity liquid to an object to be applied (i.e., application object W) in a belt shape. Examples of the high-viscosity liquid which can be handled by the application apparatus 10 include variety of liquids or fluids, such as materials used in a manufacturing process of industrial products, such as sheet-steel reinforcement materials, heat dissipation gels, silicone materials, as well as food materials, such as gummies, chewy candies, mayonnaise, and cheese.

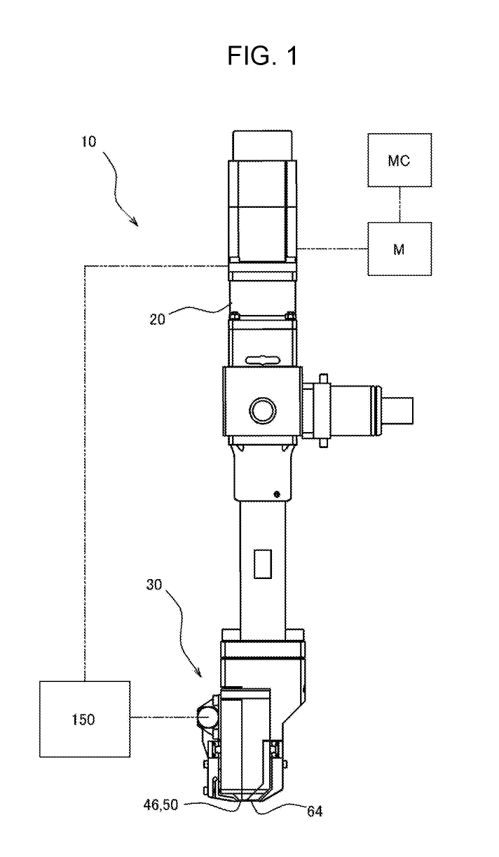

As illustrated in FIG. 1, the application apparatus 10 includes a fluid feeding device 20 and the nozzle 30. In addition, the application apparatus 10 includes a control device 150 for controlling operations of the fluid feeding device 20 and the nozzle 30. As illustrated in FIGS. 14A-14B, the application apparatus 10 operates the nozzle 30 along a given course, relatively to the application object W, where the nozzle 30 may be attached to a manipulator M, such as an articulated robot. At the same time, the application apparatus 10 discharges from the nozzle 30 the fluid P supplied from the fluid feeding device 20. Therefore, the fluid P can be applied to the application object W along the demanded applying course.

The fluid feeding device 20 includes a pump for supplying the fluid P to the nozzle 30. Although any kind of pumps may be adopted as the pump used for the fluid feeding device 20, a so-called uniaxial eccentric screw pump is adopted in this embodiment. Specifically, the uniaxial eccentric screw pump which constitutes the fluid feeding device 20 is comprised of a uniaxial eccentric screw pump including a male-threaded rotor (not illustrated) which eccentrically rotates by receiving a driving force, and a stator (not illustrated) of which the inner circumferential surface is formed in a female-threaded shape. The fluid feeding device 20 is connected to the nozzle 30.

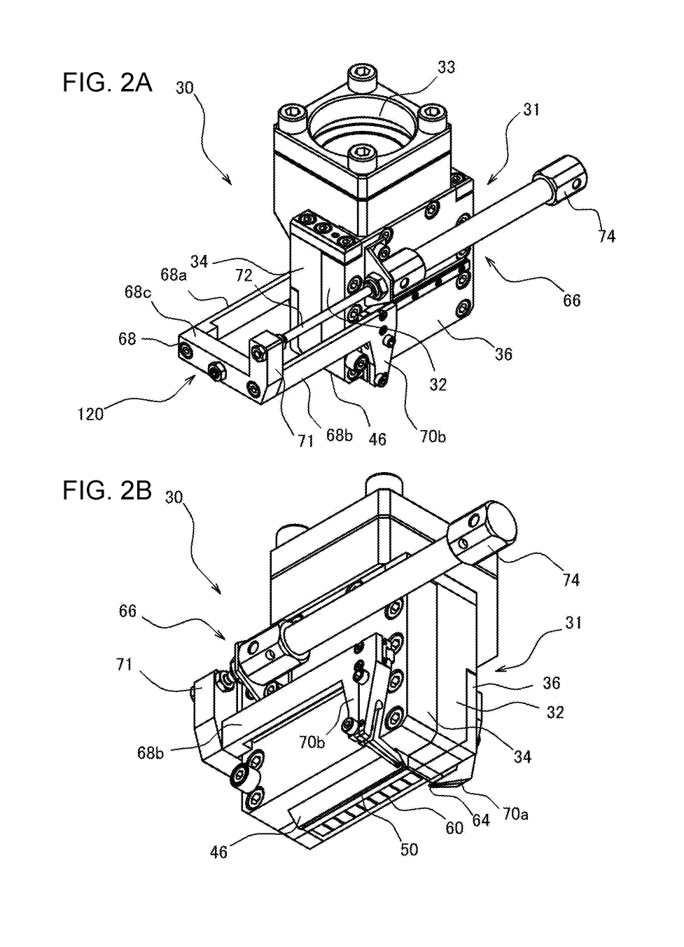

The nozzle 30 is to discharge the fluid P supplied from the fluid feeding device 20 in the belt shape to apply the fluid P to the application object W. As illustrated in FIGS. 2A-2B to 4A-4B, the nozzle 30 includes a discharging means 100, a fixing means 110, and a cutting means 120. The discharging means 100 is to discharge the fluid P to be applied to the application object W in the belt shape. The fixing means 110 is to fix the fluid P to the application object W by blowing compressed gas (compression air in this embodiment) against the fluid P discharged toward the application object W from the discharging means 100. Further, the cutting means 120 is to cut off the fluid P discharged from the discharging means 100.

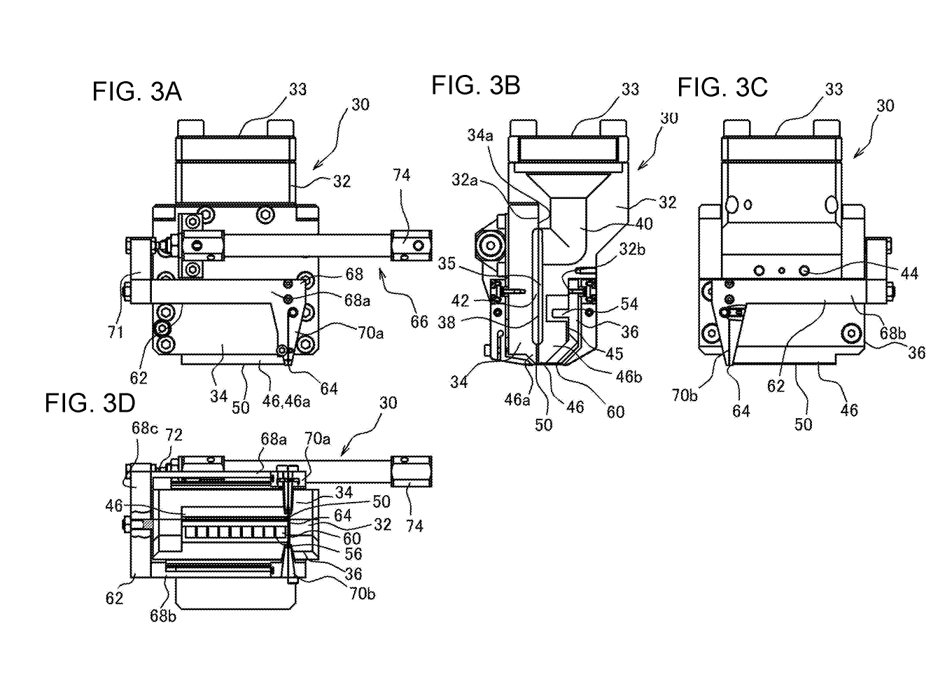

The discharging means 100 and the fixing means 110 among the means which constitute the nozzle 30 are comprised of three structures, a first structure 32, a second structure 34, and a third structure 36 which constitute a nozzle body 31. Specifically, as illustrated in FIG. 3A, the discharging means 100 is comprised of a combination of the first structure 32 and the second structure 34. Further, the fixing means 110 is comprised of a combination of the second structure 34 and the third structure 36. Further, the cutting means 120 is attached to the nozzle body 31 so as to be driven with respect to the nozzle body 31.

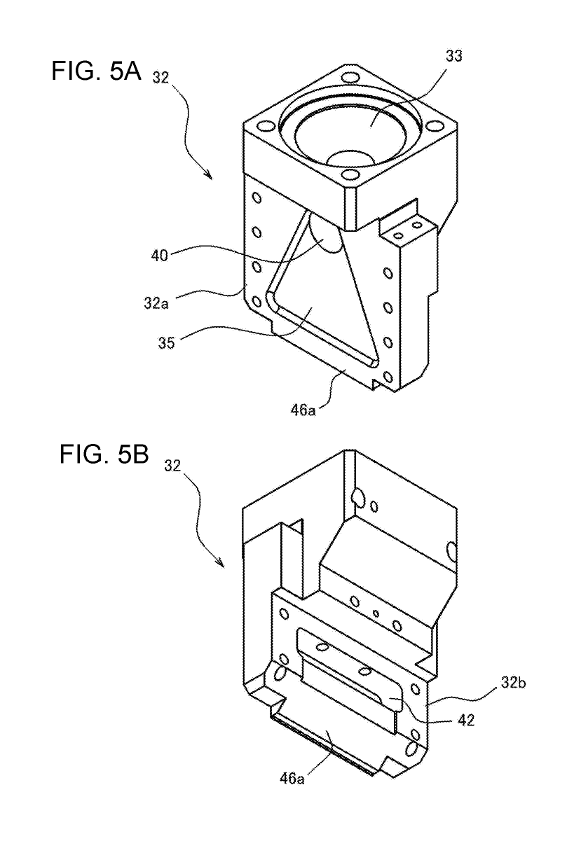

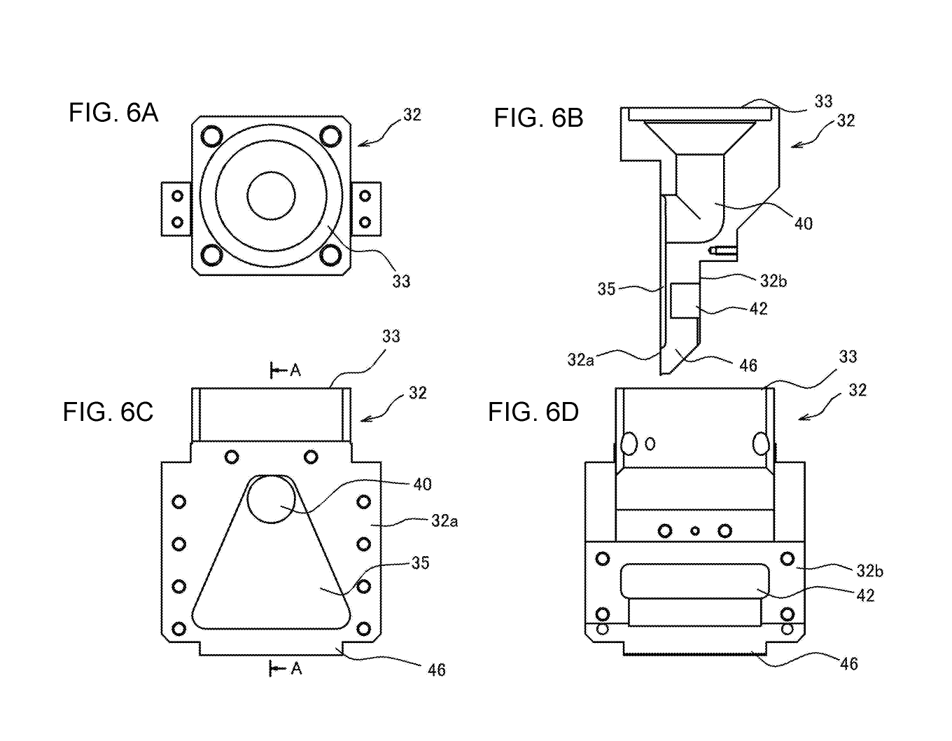

As illustrated in FIGS. 5A-5B and 6A-6D, the first structure 32 has a connection port 33 on the top surface side. The connection port 33 is to connect to the uniaxial eccentric screw pump which constitutes the fluid feeding device 20. A recess 35 is formed in a surface which is being joined to the second structure 34 described later in detail (hereinafter, also referred to as “the joining surface 32a”) among the side surfaces of the first structure 32.

A recess 36 constitutes a fluid passage 38 through which the fluid P supplied to the nozzle 30 from the fluid feeding device 20 passes. The recess 36 communicates with the connection port 33 via an internal passage 40 formed inside the first structure 32. The recess 36 is a dent formed substantially in a triangular shape when the joining surface 32a is viewed from the front, and is formed flared toward the bottom surface side from the top surface side.

Further, a recess 42 and a gas introduction port 44 are formed in a surface where the third structure 36 described later in detail is to be joined (hereinafter, also referred to as “the joining surface 32b”) among the side surfaces of the first structure 32. The recess 42 constitutes a gas passage 45 through which gas (air in this embodiment) introduced from outside passes. Further, the gas introduction port 44 is a portion which is plumbed and connected to a gas feeding device (not illustrated) which supplies the gas to the nozzle 30. The gas introduction port 44 communicates with the recess 42 via an internal passage 44a formed inside the first structure 32. Thus, the gas can be supplied to the gas passage 45 via the internal passage 44a by introducing the gas into the gas introduction port 44.

A portion of the first structure 32 on the bottom side of the nozzle 30 (hereinafter, also referred to as “the discharge part constituting part 46a”) is formed tapered toward the joining surface 32a side from the joining surface 32b side. The discharge part constituting part 46a constitutes a discharge part 46 by a combination with a discharge part constituting part 46b of the second structure 34 described later in detail.

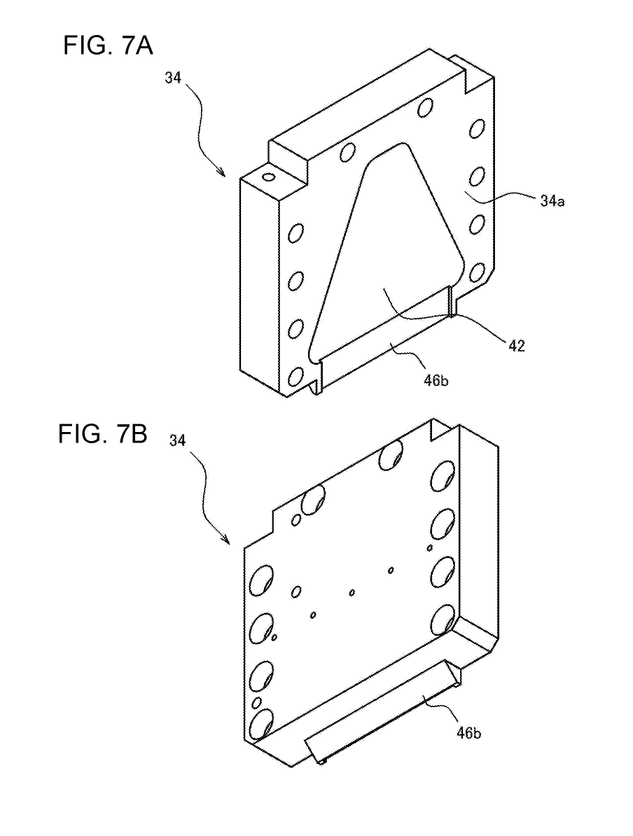

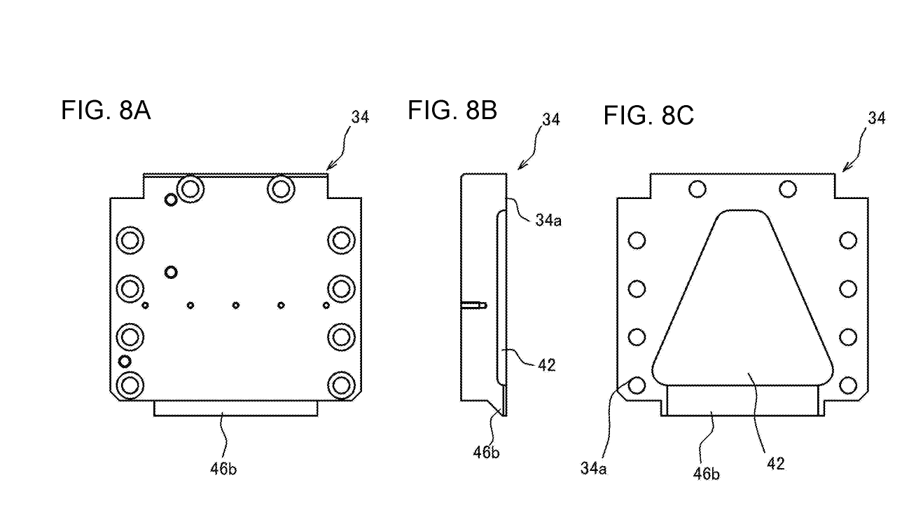

As illustrated in FIGS. 7A-7B and 8A-8C, the second structure 34 is a structure having a substantially flat plate shape. The second structure 34 is a structure to be joined to the first structure 32. The second structure 34 has a recess 48 in a side surface to be joined to the joining surface 32a of the first structure 32 (hereinafter, also referred to as “the joining surface 34a”).

Similar to the recess 36 on the first structure 32 side, the recess 48 is a dent formed substantially in a triangular shape when it is viewed from the front and it is formed flared toward the bottom surface side from the top surface side. The recess 48 is formed at a position corresponding to the recess 36 of the first structure 32. Thus, as illustrated in FIGS. 3A-3D, when the first structure 32 and the second structure 34 are joined, the recess 48 and the recess 36 are combined to form the fluid passage 38. The discharge part constituting part 46b is formed in a portion of the second structure 34 on the bottom side of the nozzle 30. The discharge part constituting part 46b is a portion which constitutes the discharge part 46 by a combination with the discharge part constituting part 46a of the first structure 32.

As illustrated in FIGS. 3A-3D, a discharge port 50 which is opened on the bottom side of the nozzle 30 is formed in the discharge part 46. The discharge port 50 is a slit-shaped opening formed in order to discharge the fluid P supplied via the fluid passage 38 formed by the first structure 32 and the second structure 34. That is, in a state illustrated in FIG. 3C, the discharge port 50 has a slit-shaped opening area of which the dimension (width) in the lateral directions (long-side directions) is significantly larger than the dimension in the vertical directions (short-side directions).

Further, as illustrated in FIG. 3B, the fluid passage 38 is formed to have a flow path cross-sectional area which decreases toward downstream of a flow of the fluid P (i.e., on the discharge part 46 side) relative to a flow path cross-sectional area at an upstream side (i.e., on the connection port 33 side). Specifically, the fluid passage 38 is significantly reduced in its flow path cross-sectional area near the discharge part 46.

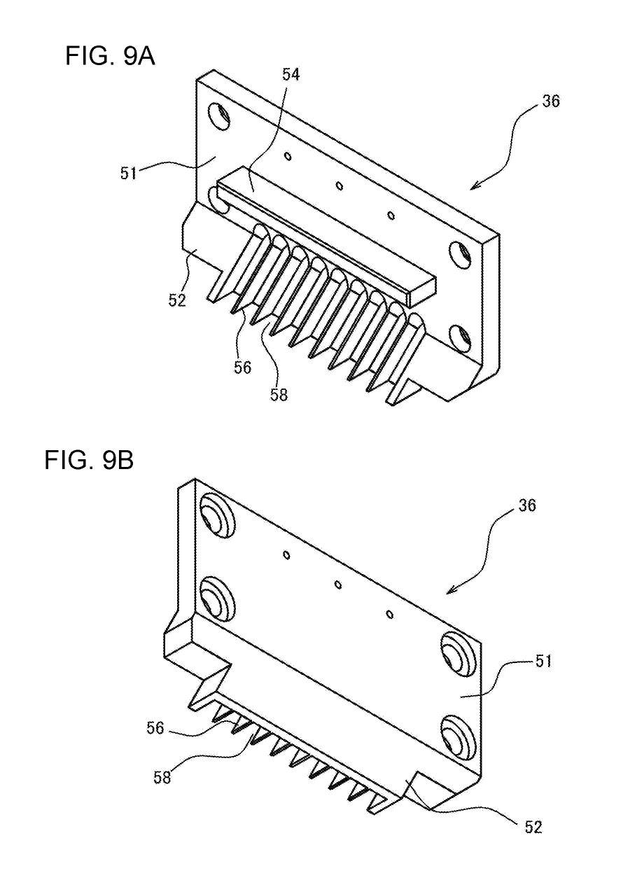

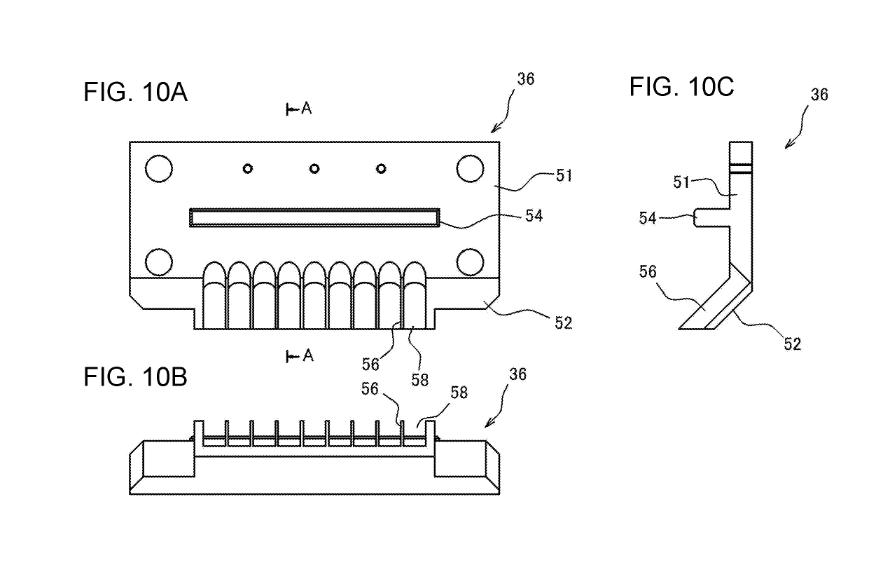

As illustrated in FIGS. 3A-3D, the third structure 36 forms the gas passage 45 by a combination with the first structure 32. As illustrated in FIGS. 9A-9B and 10A-10C, the third structure 36 is a member having a joining part 51 and an inclined part 52 which are formed continuously from each other. The joining part 51 is a portion having a substantially flat plate shape to be joined to the joining surface 32b of the first structure 32. A protrusion 54 having a substantially rectangular parallelepiped shape is provided to the joining part 51. The protrusion 54 is provided at a position corresponding to the recess 42 formed in the first structure 32 in a state where the first structure 32 and the third structure 36 are assembled.

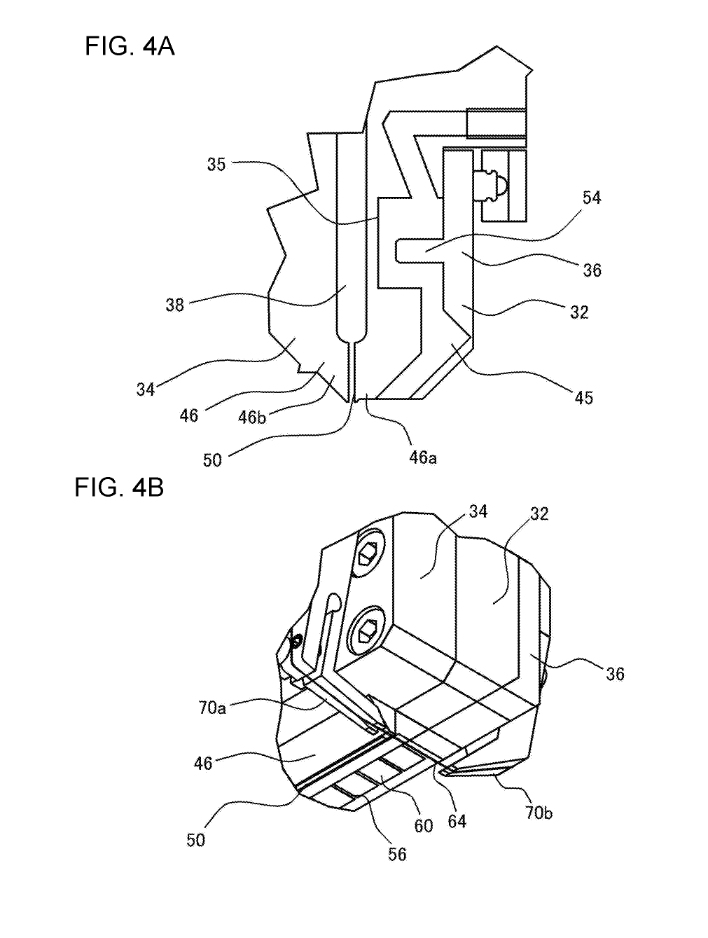

The protrusion 54 is smaller than the recess 42 so as to have a size to fit into the recess 42. When the third structure 36 is assembled with the first structure 32, the protrusion 54 is fitted into the recess 42 and, thus, the gas passage 45 having a cross-sectional shape of an elbow-shaped bend as illustrated in FIGS. 3B and 4A is formed.

Further, as illustrated in FIGS. 9A-9B and 10A-10C, the inclined part 52 is a portion which continues downwardly from the joining part 51, and inclines along the discharge part constituting part 46a of the first structure 32. Many partitions 56 are formed at a given interval in a surface of the inclined part 52, which opposes to the first structure 32 in the assembled state of the nozzle 30. As illustrated in FIGS. 3A and 3C, the partitions 56 project so as to contact the joining surface 32b in the assembled state of the nozzle 30. Further, each cavity 58 formed between the adjacent partitions 56 communicates with the gas passage 45 to form a discharge port for air (hereinafter, also referred to as “the air blow-out port 60”). Thus, air which passed through the gas passage 45 is distributed to each cavity 58 formed between the partitions 56 and is blown out from each air blow-out port 60.

As illustrated in FIGS. 3A-3D and other drawings, the discharging means 100 is formed by the first structure 32 and the second structure 34, as described above. The discharging means 100 is constituted by a portion which extends from the connection port 33 formed on the top surface side of the nozzle body 31 to the discharge part 46 formed on the bottom side via the fluid passage 38. The discharging means 100 can discharge the fluid P in the belt shape from the discharge port 50 formed in the discharge part 46.

The fixing means 110 is formed by the first structure 32 and the third structure 36, as described above. The fixing means 110 can blow out the compressed gas (air) supplied to the gas introduction port 44, from the air blow-out port 60 via the internal passage 44a and the gas passage 45. The inclined part 52 of the third structure 36 where the air blow-out port 60 is formed inclines toward the discharge part 46 (discharge port 50). Thus, the fixing means 110 can blow the compressed gas (air) against the fluid P discharged from the discharge port 50 of the discharging means 100.

The cutting means 120 is to cut off the fluid P discharged from the discharge port 50. The cutting means 120 is attached to the nozzle body 31. Specifically, the cutting means 120 has a slide structure 62, a wire 64, and a drive mechanism 66. The slide structure 62 has a body 68 having a substantially channel shape in the plan view and wire holders 70a and 70b. The body 68 has parallel portions 68a and 68b disposed substantially parallel to each other and a crossing portion 68c which intersects with (substantially perpendicular to) the parallel portions 68a and 68b, and connects both the parallel portions 68a and 68b.

The slide structure 62 can operate so that the parallel portions 68a and 68b slide in the long-side directions of the discharge port 50 along outer surfaces of the second structure 34 and the third structure 36, respectively. The wire holders 70a and 70b and a connection 71 are integrally formed in the parallel portions 68a and 68b. The wire holders 70a and 70b are formed so as to extend toward the discharge port 50 (downward) from the parallel portions 68a and 68b, respectively. The wire holders 70a and 70b are desirably what can hold the wire 64 in a state where the wire 64 is fully tensioned. Specifically, like the holding structure of a bowstring of a musical instrument, the wire holders 70a and 70b may have a structure where one end of the wire 64 is fixed and the other end is wound up to cause the tension to act in the wire 64. Alternatively, the wire holders 70a and 70b may have a structure where one end of the wire 64 is fixed and the other end is pulled by a spring etc. to cause the tension to act in the wire 64. The connection 71 is formed in an end of the crossing portion 68c on the parallel portion 68b side so that it extends upwardly. A cylinder shaft 72 of the drive mechanism 66, described later in detail, is connected to the connection 71.

The wire 64 is a wire member comprised of a piano wire etc., and is held by the wire holders 70a and 70b. The wire 64 is held immediately below the discharge port 50 so that it will not be loosened in the short-side directions of the opening area which constitutes the discharge port 50.

The drive mechanism 66 is to slide the slide structure 62 substantially horizontally in the long-side directions of the discharge port 50. Although the drive mechanism 66 may adopt any kind of mechanisms, an air cylinder mechanism is adopted in this embodiment. That is, the drive mechanism 66 includes the cylinder shaft 72 comprised of an air cylinder and a drive source 74. The cylinder shaft 72 is connected to the connection 71 of the slide structure 62. Thus, when the drive source 74 operates to reciprocate the cylinder shaft 72, the wire 64 attached to/between the wire holders 70a and 70b of the slide structure 62 can be slid in the long-side directions of the discharge port 50, below the discharge port 50. Note that, although what is provided with the air cylinder mechanism as the drive mechanism 66 is illustrated in this embodiment, the present invention is not limited to this structure and may adopt a ball screw mechanism etc.

### [Method of Applying Fluid P Using Application Apparatus 10]

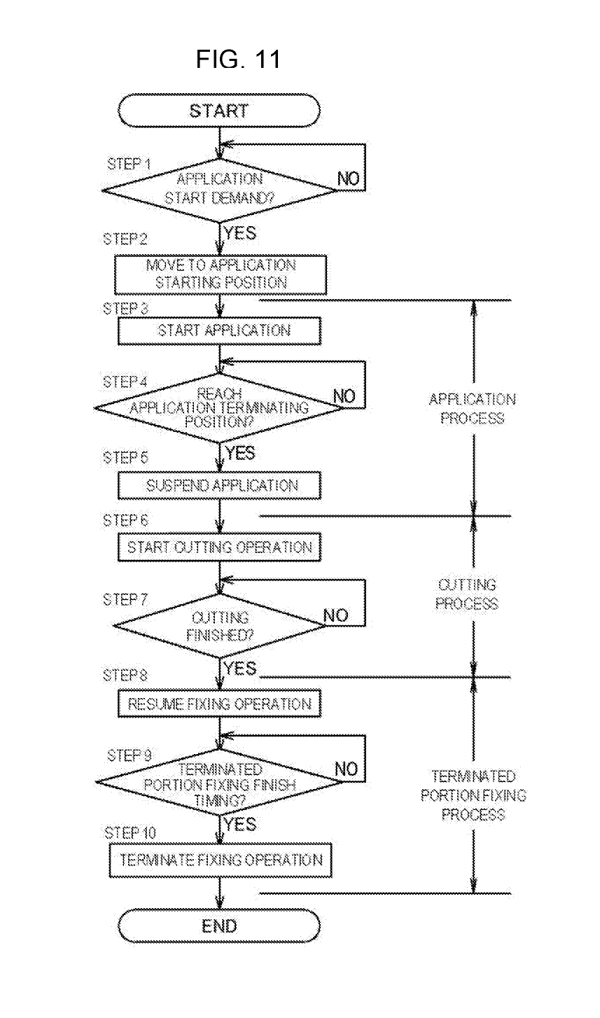

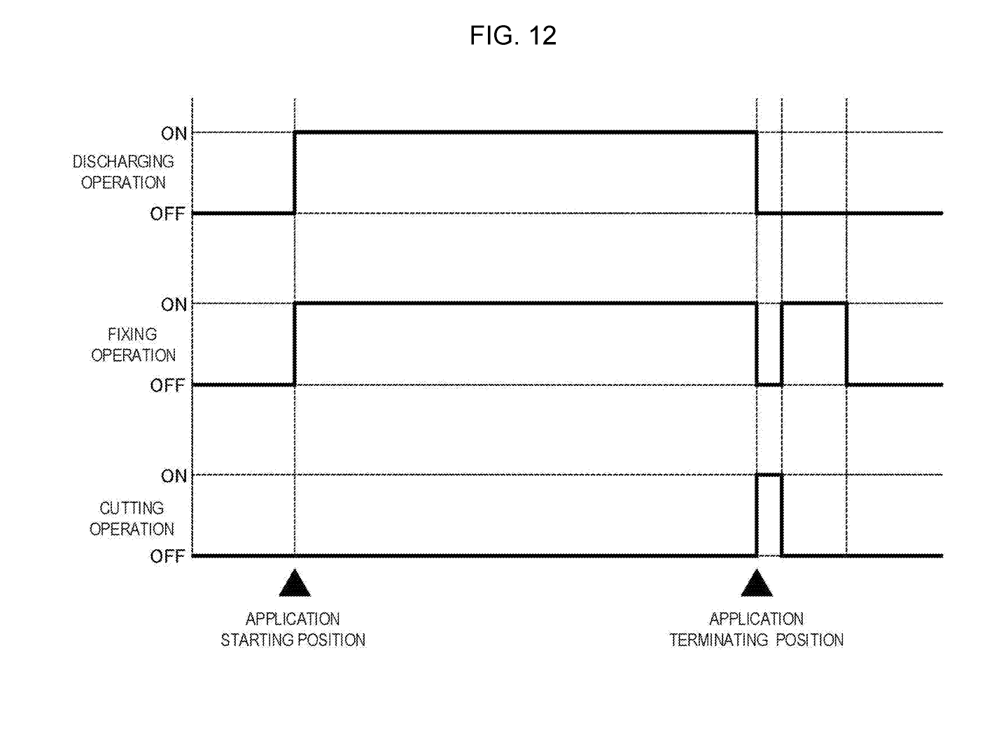

An application work of the fluid P using the application apparatus 10 is performed in accordance with a flowchart illustrated in FIG. 11 and a timing chart illustrated in FIG. 12. Thus, as illustrated in FIG. 14A, the fluid P can be applied in a belt shape to the application object W. Hereinafter, the method of applying the fluid P according to this embodiment is described in detail with reference to FIGS. 11 and 12.

### (Step 1)

When performing the application work of the fluid P by the application apparatus 10, a determination is made at Step 1 as to whether an application start demand is first outputted from a host control device (not illustrated). Here, if the application start demand is inputted, the control flow transits to Step 2.

### (Step 2)

Based on the application start demand inputted at Step 1, a controller MC provided for controlling a manipulator M relatively moves the nozzle 30 and the application object W so that the nozzle 130 reaches at a location where the discharge port 50 opposes to an application starting position on the application object W. Specifically, when the nozzle 130 is connected to the manipulator, the manipulator is operated by the controller MC to move the nozzle 30 to the application starting position. Then, the control flow transits to Step 3.

### (Step 3)

At Step 3, the application of the fluid P is going to be started. That is, at Step 3, a discharging operation where the fluid P is discharged, a fixing operation where the fluid P is fixed, and a relatively-moving operation where the nozzle 30 is relatively moved with respect to the application object W, are performed complexly. Specifically, as illustrated in FIG. 14B, the control by the controller MC causes the nozzle 30 and the application object W to relatively move along the given application course, and at the same time, the control by the control device 150 causes the discharging operation and the application operation to be carried out. Here, the discharging operation is an operation where the fluid P is discharged toward the application object W from the discharging means 100 formed in the nozzle 30. More specifically, the control device 150 performs a motion control of the fluid feeding device 20 to supply the fluid P to the discharging means 100 so that the fluid P is discharged onto the surface of the application object W from the discharge port 50.

Further, the fixing operation is an operation where the compressed gas is blown by the fixing means 110 to the fluid P discharged to the application object W by the discharging operation. By carrying out the fixing operation, the fluid P is fixed to the application object W. Thus, when the relatively-moving operation of the nozzle 30 with respect to the application object W, the discharging operation, and the fixing operation are started, the control flow transits to Step 4.

### (Step 4)

At Step 4, the control device 150 examines whether the application of the fluid P by the nozzle 30 has reached to an application terminating position. Here, if the nozzle 30 has not reached the application terminating position, the relatively-moving operation of the nozzle 30 with respect to the application object W, the discharging operation, and the fixing operation are continued. On the other hand, if the nozzle 30 has reached the application terminating position, the control flow transits to Step 5. Note that it may be possible to confirm whether the application of the fluid P has reached the application terminating position based on the coordinates of the manipulator which can be obtained by the controller MC. Alternatively, a method of detecting the nozzle 30 having reached the given position by an additionally-provided sensor etc., or a method of detecting a time required from the moving start of the nozzle 30 may also be adopted as the method of recognizing the nozzle 30 having reached the application terminating position.

### (Step 5)

At Step 5, the application of the fluid P is suspended. That is, the relatively-moving operation, the discharging operation, and the fixing operation are suspended. Thus, the application process which is carried out over Steps 3 to 5 is finished. Then, the control flow transits to Step 6.

### (Step 6)

At Step 6, a cutting operation is going to be started in a state where the blow of the compressed gas (air) by the fixing operation is suspended at Step 5. That is, the operation of cutting the fluid P (cutting operation) is started by moving the wire 64 which constitutes the cutting means 120 from one side to the other side in the long-side direction of the opening area which constitutes the discharge port 50. Then, the control flow transits to Step 7.

### (Step 7)

At Step 7, if the movement of the wire 64 from one side to the other side in the long-side direction of the discharge port 50 is finished, the control flow transits to Step 8 because the cutting of the fluid P is considered to be finished.

### (Step 8)

At Step 8, the fixing operation is resumed in order to certainly fix the terminated portion of the fluid P which was cut in the cutting process to the application object W (termination fixing process). That is, at Step 8, a compressed gas feeding device (not illustrated) connected to the nozzle 30 is operated to blow the compressed gas against the terminated portion of the fluid P cut by the fixing means 110. Thus, the terminated portion of the application object W can be fixed to the surface of the application object W, similar to the intermediate portion. Then, the control flow transits to Step 9.

### (Step 9)

After the fixing operation is resumed at Step 8, if it is confirmed that a given period of time has lapsed at Step 9, the control flow transits to Step 10.

### (Step 10)

At Step 10, the supply of the compressed gas by the compressed gas feeding device (not illustrated) connected to the nozzle 30 is suspended in order to terminate the fixing operation. Thus, the termination fixing process performed over Steps 8 to 10 is finished, and a series of application works is over.

As described above, the nozzle 30 used in the application apparatus 10 of this embodiment is provided with the cutting means 120 which can cut the fluid P by moving the wire 64. Thus, even if the fluid P used for the application is high-viscosity liquid with very poor anti-drip performance, the cutting means 120 can cut the fluid P neatly (gives a clean cut) when terminating the discharge of the fluid P for the application. Therefore, according to the application apparatus 10 and the nozzle 30, it is difficult to reduce the application quality, resulted from irregularities on the terminated ends of the fluid P applied to the application object W and/or the starting ends of the next application work. Further, according to the application apparatus 10 and the nozzle 30, it is not necessary to make the clearance between the nozzle 30 and the application object W extremely small, and the problem of the nozzle 30 and the application object W being, for example, interfered, can also be reduced.

Note that, in this embodiment, one example in which the wire 64 is attached so as to cross and bridge over the opening area in the short-side directions of the opening area which constitutes the discharge port 50 and it is moved from one side to the other side in the long-side direction when cutting the fluid P, is illustrated; however, the present invention is not limited to this structure. That is, contrary to the structure illustrated in this embodiment, the wire 64 may be attached so as to cross and bridge over the opening area in the long-side direction of the opening area which constitutes the discharge port 50 and it may be moved from one side to the other side in the short-side direction to cut the fluid P.

Further, although what cuts the fluid P using the wire 64 is illustrated in this embodiment as one example of the cutting means 120, the present invention is not limited to this structure. Specifically, if the fluid P is not damaged by action of heat, i.e., it is neither hardened nor deteriorated by heat, the apparatus may be structured such that the temperature of the compressed gas which is blown out from the fixing means 110 can be varied, and the heated compressed gas is blown against the fluid P to reduce the viscosity of the part where the fluid P is wanted to be cut, compared with other parts. By constructing in this way, it is possible to cut the fluid P and/or stimulate the cutting of the fluid P. In addition, if such a structure is adopted, it is possible to share the components which constitute the fixing means 110 with the cutting means 120. Therefore, the structure of the apparatus can be simpler.

Further, although the cutting means 120 cuts the fluid P by simply sliding the wire 64, the present invention is not limited to this structure. Specifically, if the fluid P is not damaged by action of heat, i.e., it is neither hardened nor deteriorated by heat, the apparatus may have a structure in which the temperature of the wire 64 can be raised by, for example, conducting electricity, and the fluid P may be cut in a state where the temperature of the wire 64 is raised. According to this structure, effects, such as viscosity of the fluid P is reduced by locally heating a portion of the fluid P which contacts the wire 64 at the time of cutting to reduce cutting resistance of the fluid P, can be expected. Alternatively, the apparatus may also be structured such that a supersonic vibrator etc. can vibrate the wire 64. According to this structure, the cutting of the fluid P can be performed easily by vibrating the wire at the time of cutting.

Further, the diameter and material of the wire 64 may suitably be selected. That is, the wire diameter and material may be designed optimally in consideration of a kind of the fluid P used for the application, characteristics of the fluid P, such as the viscosity, the application thickness to the application object W, a moving speed of the wire 64 when performing the cutting operation, etc. In more detail, if the diameter of the wire 64 is thinner, the anti-drip performance of the fluid P becomes better. Further, if the moving speed of the wire 64 is faster, the anti-drip performance of the fluid P becomes better. In order to improve the anti-drip performance of the fluid P, it is desirable to reduce a frictional resistance between the wire 64 and the fluid P. Specifically, it is desirable to minimize the frictional resistance between the wire 64 and the fluid P by applying a surface treatment to the wire 64, or coating the wire 64.

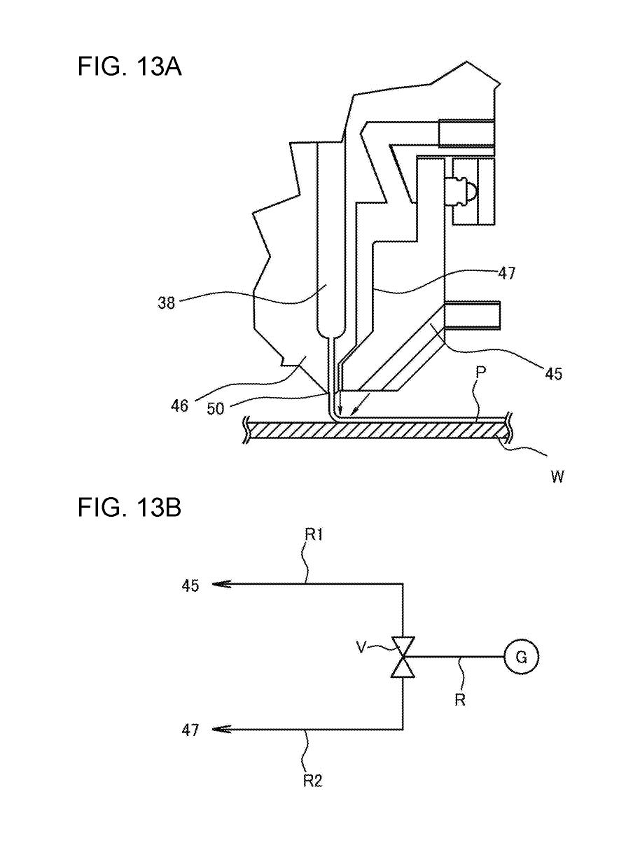

Alternatively, the cutting means 120 may cut the fluid P, for example, by compressed gas. Specifically, for example, as illustrated in FIG. 13A, the apparatus may be structured such that a gas passage 47 for cutting through which the compressed gas passes is additionally formed in the nozzle 30 in addition to the gas passage 45 for the fixing means 110. In addition, an opening width of an end opening portion of the gas flow path 47 for cutting (a dimension in the short-side directions) may be made narrower than the opening width of the gas passage 45 formed for fixing to discharge the compressed gas blown for cutting, stronger than the gas for fixing. With such a structure, the compressed gas is designed to be blown toward the fluid P from the gas passage 47 for cutting at the time of cutting. Therefore, the cutting of the fluid P is possible without using the wire 64.

Furthermore, if the gas passage 47 for cutting constitutes the cutting means 120, a gas supply source G for the fixing means 110, which supplies the compressed gas to the gas passage 45, can be shared. Specifically, as illustrated in FIG. 13B, a flow path R connected to the gas supply source G is branched at an intermediate location to a branch flow path R1 connected to the gas passage 45 and a branch flow path R2 connected to the gas passage 47 for cutting. Further, if a selector valve V is provided at the branched position of the branch flow paths R1 and R2, the compressed gas supplied from the gas supply source G can be selectively supplied to either the branch flow path R1 or R2.

If such a structure is adopted, when stopping the discharging operation and cutting the fluid P, the branch flow path R2 is communicated with the gas supply source G by the operation of the selector valve V to supply the compressed gas to the gas passage 47 for cutting. Therefore, the fluid P can be cut. Further, the selector valve V is switched after the cutting is finished, the branch flow path R1 is communicated with the gas supply source G to supply the compressed gas to the gas passage 45, and the terminated portion of the applied fluid P can then be fixed. Note that, although one example in which the single selector valve V is enabled to switch between the branch flow paths R1 and R2 is illustrated in FIG. 13B, the present invention is not limited to this structure. A valve may be provided in each of the branch flow paths R1 and R2, and the valves are alternately opened and closed to selectively supply the compressed gas to either the branch flow path R1 or R2.

Further, the nozzle 30 used in the application apparatus 10 includes the fixing means 110, and the compressed gas is blown to the fluid P discharged toward the application object W from the discharging means 100 to fix the fluid P to the application object W. Thus, even if high-viscosity liquid is used as the fluid P for application, it is reduced that the applied fluid P floats at an intermediate location or a terminated portion of the application course, and it becomes possible to improve the application quality.

Further, in the application apparatus 10 of this embodiment, the fixing operation is continuously carried out from the start to the end of the discharging operation. Thus, according to the application apparatus 10, it is possible to firmly fix the fluid P to the application object W not only at the terminated portion of the fluid P applied to the application object W but also at the intermediate location of the application course. Therefore, it is possible to further improve the application quality. Note that, although one example in which the fixing operation is continuously carried out from the start to the end of the discharging operation is illustrated in this embodiment, the present invention is not limited to this configuration. For example, the fixing operation may be carried out intermittently, as needed.

As described above, in the application apparatus 10 of this embodiment, because the fixing operation is suspended when ending the discharging operation, the fluid P can be cut neatly without being exposed to an air current when being cut. Further, in the application apparatus 10, the fixing operation is resumed after the execution of the cutting operation to fix to the application object W the terminated portion of the fluid P discharged to the application object W. Thus, according to the application apparatus 10 of this embodiment, the cut shape of the terminated portion of the fluid P is neat on the application object W, and the fluid P is firmly fixed without floating, etc.

Note that, in the application apparatus 10, the fixing operation is suspended when performing the cutting operation; however, the present invention is not limited to this configuration. Specifically, the fixing operation may not be suspended at the time of the execution of the cutting operation, and the intensity of the air current blown out during the fixing operation may be reduced. Further, in the application apparatus 10, although the fixing operation is resumed after the execution of the cutting operation to fix the fluid P certainly at the terminated portion, the present invention is not limited to this configuration, and it may be structured such that the fixing operation is not resumed.

As described above, the nozzle 30 has the flow path cross-sectional area at the part on the discharge port 50 side (near the discharge part 46), of the fluid passage 38 through which the fluid P passes from the supply source side to the discharge port 50 smaller than the flow path cross-sectional area on the fluid feeding device 20 side (the connection port 33 side) which is the supply source of the fluid P. With such a structure, even if the fluid P used for the application is high in viscosity, the sufficient discharge pressure can be obtained. Note that, in this embodiment, in order to obtain the sufficient discharge pressure, the structure in which the flow path cross-sectional area of the fluid passage 38 is reduced near the discharge part 46 is illustrated, but the present invention is not limited to this structure. That is, the fluid passage 38 may substantially be entirely uniform in the flow path cross-sectional area.

As described above, in the application apparatus 10 of this embodiment, the fluid feeding device 20 is to pump the fluid P by the uniaxial eccentric screw pump. Thus, in the application apparatus 10, the fluid P can stably be supplied to the nozzle 30 at a constant pressure and with high precision without pulsation etc., and the application quality of the fluid P to the application object W can be further improved.

The present invention is not limited to the structures and configurations illustrated in the embodiment described above, and it can be appreciated by a person skilled in the art that there may be other embodiments based on the teachings and spirit of the invention without departing from the appended claims.

The present invention can be used in order to apply the fluid in a belt shape, and it can be used suitably when the fluid to be applied is especially a high-viscosity liquid.

1. A nozzle, comprising:
a discharging unit having a wide discharge port that is opened so that fluid is dischargeable in a belt shape to be applied to an application object; and
a cutting unit for cutting the fluid discharged from the discharge port,
wherein the cutting unit is cuttable of the fluid by a wire that is movable from one side to the other side of an opening area that constitutes the discharge port.

2. A nozzle, comprising:
a discharging unit having a wide discharge port that is opened so that fluid is dischargeable in a belt shape to be applied to an application object;
a fixing unit for fixing the fluid to the application object by blowing compressed gas to the fluid discharged from the discharging unit toward the application object; and
a cutting unit for cutting the fluid discharged from the discharge port.

3. The nozzle according to claim 2, wherein the cutting unit is cuttable of the fluid by a wire that is movable from one side to the other side of an opening area that constitutes the discharge port.

4. The nozzle according to claim 3, wherein the wire is oriented in short-side directions of the opening area that constitutes the discharge port, and is cuttable of the fluid by moving from one side to the other side in a long-side direction.

5. The nozzle according to claim 2, wherein the cutting unit cuts the fluid by blowing compressed gas to the fluid.

6. The nozzle according to claim 1, wherein a passage through which the fluid passes from a supply source side to the discharge port is provided, a flow path cross-sectional area of a part of the passage on the discharge port side being smaller than a flow path cross-sectional area on the supply source side.

7. An application apparatus, comprising the nozzle according to claim 1 and
a fluid feeding device for supplying the fluid to the nozzle,
wherein the application apparatus is executable of a discharging operation where the fluid is discharged from the discharging unit of the nozzle toward the application object, and a cutting operation where, when ending the discharging operation, a wire that constitutes the cutting unit is moved from one side to the other side of an opening area that constitutes the discharge port, and cuts the fluid.

8. The application apparatus according to claim 7, comprising a fixing unit that is executable of a fixing operation where the fluid is fixed to the application object by blowing compressed gas to the fluid discharged from the discharging unit toward the application object, wherein the fluid is applicable to the application object by executing the discharging operation and the fixing operation.

9. The application apparatus according to claim 8, wherein the fixing operation continues from the start to the end of the discharging operation.

10. The application apparatus according to claim 8, wherein, when ending the discharging operation, the cutting operation is executed in a state where the fixing operation is suspended, and
wherein, after the execution of the cutting operation, the fixing operation is resumed to fix to the application object, a terminated portion of the fluid discharged to the application object.

11. The application apparatus according to claim 7, wherein the fluid feeding device pumps the fluid by a uniaxial eccentric screw pump.

12. A method of applying fluid, the method comprising the steps of:
applying the fluid to an application object by executing a discharging operation where the fluid is discharged toward the application object from a discharging unit of a nozzle including the discharging unit having a wide discharge port that is opened so that the fluid is dischargeable in a belt shape to be applied to the application object and a cutting unit for cutting the fluid discharged from the discharge port; and
cutting the fluid, when the applying step is ended, by moving a wire that constitutes the cutting unit from one side to the other side of an opening area that constitutes the discharge port.

13. The method according to claim 12, wherein the nozzle further includes a fixing unit for fixing the fluid to the application object by blowing compressed gas to the fluid discharged from the discharging unit toward the application object, and
wherein, during the step of applying the fluid, a fixing operation where the compressed gas is blown by the fixing unit to fix the fluid is executed, in addition to the discharging operation.

14. The method according to claim 12, wherein the step of cutting the fluid is executed after the step of applying the fluid is ended by suspending the discharging operation and the fixing operation, and
the method further comprising a step of, after the execution of cutting the fluid step, fixing to the application object a terminated portion of the fluid discharged to the application object by resuming the fixing operation.
